(19) United States
(12) Patent Application Publication
(10) Pub. No.: US 2004/0172278 A1
(43) Pub. Date: Sep. 2, 2004

(54) System for completing a requisitioning cycle

(76) Inventor: Kevin R. Bell, Hanna, WY (US)

Correspondence Address: Law Office of Steven B. Leavitt, 9914 Waterview Parkway, Rowlett, TX, 75089, US

(21) Appl. No.: 10/787,637

(22) Filed: Feb. 26, 2004

Related U.S. Application Data
(60) Provisional application No. 60/450,740, filed on Feb. 27, 2003.

(51) Int. Cl. G06F 17/60

(52) U.S. Cl. 705/1

(57) ABSTRACT

A method for combining and synchronizing data in an enterprise resource planning system (ERP) with an interactive electronic technical manual (IETM) using middleware. First the middleware software receives a request for information about a product from the IETM. Then the request is processed into a request the ERP will recognize. Next the middleware software sends the processed request to the ERP. The ERP responds to the request and sends the response to the middleware software. The middleware software processes the response into a response the IETM will recognize and sends the processed response to the IETM for integration. The middleware software can also create customized IETMs from data contained within the ERP. In addition, the middleware software is connected to an original equipment manufacture's database to facilitate automatic updates of the ERP.

This application claims the benefit of U.S. Provisional Application No. 60/450,740, filed Feb. 27, 2003.

### BACKGROUND OF THE INVENTION

1. Technical Field

The invention relates to interactive electronic technical manuals and enterprise resource planning systems and more particularly to synchronizing data in the electronic technical manuals with data in the enterprise resource planning systems.

2. Description of Related Art

Interactive Electronic Technical Manuals (IETM) were developed and designed by the U.S. Department of Defense to replace traditional paper technical manuals. The primary purpose of an IETM is to support the diagnostics, maintenance, and repair of complex technical systems. It is a manual that is written for a digital format allowing it operate interactively with the user and provide immediate feedback. With the IETM, maintenance and troubleshooting procedures, parts information, theory of operation and illustrated graphics can be loaded onto computer. Today, IETM has been the preferred scheme in technical assessment and repair of complex machinery. This is due to the fact that IETM offers more advantages than the traditional scheme of paper-based technical manuals, such as allowing for relatively easy and precise identification and ordering of parts needed to complete repairs.

Traditionally, ordering parts has involved taking a customer's order over the phone which then begins a mostly paper-based journey from in-basket to in-basket around the vendor's company. The order is often keyed and re-keyed into different departments' computer systems along the way. This process results in papers having to remain in-baskets causing delays and lost orders. Further, all the keying into different computer systems invites errors. Meanwhile, it is difficult, if not impossible, for anyone in the company to truly know what the status of a given order is at any point because there is no way for the finance department, for example, to get into the warehouse's computer system to see whether the item has been shipped.

One system focused on automating systems to improve managing the supply chain and ordering process is called Enterprise Resource Planning (ERP). ERP is the practice of consolidating an enterprise's planning, manufacturing, sales and marketing efforts into one management system. ERP systems help track the flow of raw materials into an organization, the integration of the components into final products, the costs and processes associated with running the business and the delivery of products to the customer. ERP integrates all departments and functions across a company onto a single computer system that can serve many different departments' particular needs.

In the past, each department typically has its own computer system optimized for the particular ways that the department processes its work. ERP combines all the systems together into a single, integrated software program that runs off a single database so that the various departments can more easily share information and communicate with each other. Finance, manufacturing and the warehouse all still get their own software, except now the software is linked so someone in finance can look into the warehouse software to see if an order has been shipped.

ERPs are most efficient in the order fulfillment process. ERP takes a customer order and provides a software road map for automating the different steps along the path to fullfilling it. People in different departments all see the same information and can update it. When one department finishes with the order, it is automatically routed via the ERP system to the next department. The status of the order is available to anybody with proper access to the system. Many different types of ERP systems are commercially available and examples include M1 by Bowen & Grooves located in Irvine, Calif. and Vantage by Epicor Software located in Dallas, Tex.

Unfortunately, an ERP system is complex and not intended for public consumption. It assumes that the only people handling order information will be employees who are highly trained and comfortable with the technical terminology embedded in the software. It would be beneficial if the complexity of the ERP system were reduced and some of the information contained in the ERP system could be integrated into a web based IETM and then synchronized at regular intervals. It would also be beneficial if a custom IETM could be created from the information contained in the ERP system.

Currently, there is not a system or method for combining the usefulness of an IETM with the efficient functionality of an ERP and allows for synchronizing data in the IETM with the ERP. What is needed is a method that combines an IETM with ERP and synchronizes the data. The method should allow for the removal of required training to skill staff in accessing relevant areas in the ERP. The method should also allow for the creation of custom IETMs from the information contained in the ERP. It would also be beneficial if the method could update the ERP when information about vendor's products is updated.

### SUMMARY OF THE INVENTION

The Global Requisitioning Suite (GRS) of the present invention manages to integrate Interactive Electronic Technical Manuals (IETM) with Enterprise Resource Planning (ERP) and synchronize the data in the IETM with the ERP. The GRS captures ERP information and integrates the information into an IETM view. This makes it possible to order parts directly from the user's IETM knowing that the parts will be found in the user's ERP system. The GRS can also import vendor updated Original Equipment manufactures (OEM) information into a user's ERP.

With the GRS of the present invention, automatic creation of multiple IETMs from a user's ERP can also be realized. This can include warehousing and pricing information so the user's IETM contains up-to-date information for every line item within the user's ERP. This allows the removal of previously required training to skill staff in accessing relevant areas in the user's ERP. A further benefit is that this system can be optionally customized for each user's individual requirements. Each user's system can be analyzed for its data requirements so that an optimal translation mechanism from the user's ERP to a structured IETM can be realized.

The data held within the IETM will be up-to-date as of the last time an ERP capture was completed. This provides real time data such as amount of stock-on-hand. The real time data can also be customized for each user's individual requirements.

The GRS of the present invention can also import updated data from OEM's into ERP. Essentially, data is imported from a user's vendors into the user's ERP. OEM data is something that can change with little notice. Making sure such changes get mirrored in the user's ERP is beneficial to reduce ordering incorrect parts, reducing equipment down-time, and return of incorrect parts.

The GRS of the present invention can be arranged to support any ERP system. For example, GRS can be established to directly communicate with a user's ERP via ASP and XML messaging. As such, any ERP that supports ASP and XML messaging will be able to utilize the GRS.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a block diagram depicting modular placement of software for use in the present invention;

FIG. 2 is a block diagram depicting the steps for updating an interactive electronic technical manual;

FIG. 3 is a block diagram depicting the steps for the creation of a customized IETM; and

FIG. 4 is a block diagram depicting the steps for updating an enterprise resource planning system.

### DETAILED DESCRIPTION

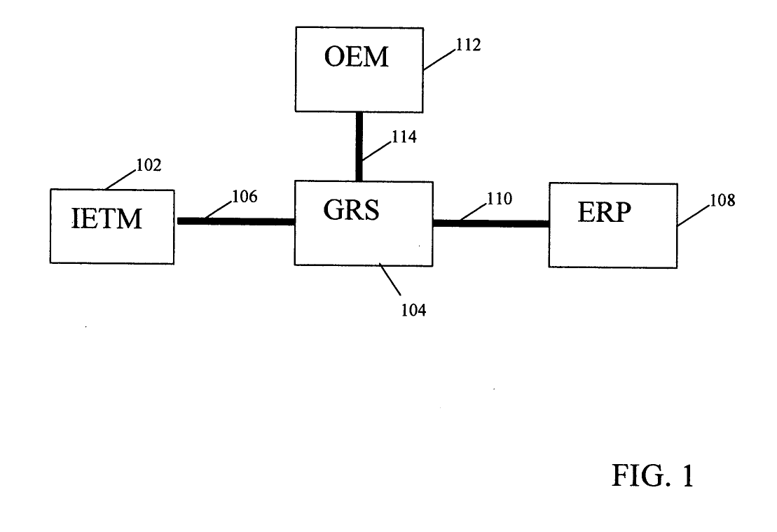

FIG. 1 is a block diagram showing Interactive Electronic Technical Manuals (IETM) 102 connected to Global Requisitioning Suite (GRS) 104 via ethernet connection 106. GRS 104 is connected to Enterprise Resource Planning (ERP) 108 via ethernet connection 110. GRS 104 is also connected to Original Equipment Manufacture (OEM) 112 via ethernet connection 114. In another embodiment, IETM 102, ERP 108, and OEM 112 are connect to GRS 104 via the Internet.

Ethernet connections 106, 110 and 114 are bi-directional and can function on a number of different protocols such as Transmission Control Protocol (TCP), User Datagram Protocol (UDP), Internet Control Message Protocol (ICMP) or other known protocols. Ethernet connections 106, 110 and 114 do not have to function on the same protocol.

IETM 102 is a typical IETM know in the art and is created by using software which provides comprehensive control and visibility of equipment parts and maintenance and ordering systems. Suitable software for creating IETM 102 includes LINKONE available from Mincom Ltd. located in Brisbane, Australia. LINKONE is used to create electronic parts catalogs (EPC) and electronic maintenance documentation (EMD) that allows all forms of electronic parts and service information, technical documentation and maintenance documentation to be available via an ethernet or the Internet. This includes, but is not limited to, parts catalogs, repair manuals, operating and commissioning instructions, maintenance and repair procedures, visual operational aids, maintenance and operating manuals, spare parts list, wiring diagrams, quality assurance documents, safety bulletins, illustrations and process/plant designs, and product updates and notices.

The text portions of IETM 102 such as general descriptions, specifications, price, and availability of goods are created using HyperText Markup Language (HTML) and Extensible Markup Language (XML). HTML defines the structure and layout of a Web document by using a variety of tags and attributes. A tag is a command inserted in a document that specifies how the document, or a portion of the document, should be formatted. Tags are used by all format specifications that store documents as text files including XML.

XML is used to update the information in IETM 102 that periodically changes. Such information is commonly referred to as network variables (NV). IETM 102 uses XML parsers to retrieve and reload the NV data. For purposes of this application, data and information have the same meaning and may be used interchangeably. Using XML parsers allows for the creation of customized tags, enabling the definition, transmission, validation, and interpretation of data between IETM 102, GRS 104, and ERP 108.

Similar to HTML, a Web Server will serve up an XML file using HTTP. Then an XML parser is used to read the XML file. The parser provides direct access to the NV data without any concern over the data's formatting. This allows for separation of the formatting in the HTML file from data that will reside in the XML file. The data can then be periodically retrieved and processed to update only the affected parts of the file. For example, in a parts list, HTML is used for information that is unlikely to change such as a general description or parts number. Alternatively, XML is used for information that is likely to change such as price or availability. The data used in the XML file to update IETM 102 is requested from GRS 104 via ethernet connection 106.

GRS 104 is middleware as the term is known in the art. Middleware acts as a software translator to take information from one operating system and covert it into a format that a second operating system can understand. The objective of GRS 104 is to retrieve information from ERP 108 and embed that information into IETM 102, which is independent of ERP 108. GRS 104 has interface translators that move data, SQL commands and applications to/from IETM 102 from/to ERP 108. GRS 104 is programmed with details such as syntax, data format, data types and catalog naming conventions used by ERP 108 and IETM 102. GRS 104, ERP 108, and IETM 102 can reside on the same platform or different ones. This allows gateways to connect clients and servers running on dissimilar networks.

GRS 104 can accept statements specified by a well-defined grammar or format, such as XML from IETM 102, translate the statements to a specific database format such as SQL, send the statements to be executed against a database, translate the results back into the well-defined format, and return the data to IETM 102. GRS 104 uses SQL or some other similar method to query ERP 108 to update IETM 102.

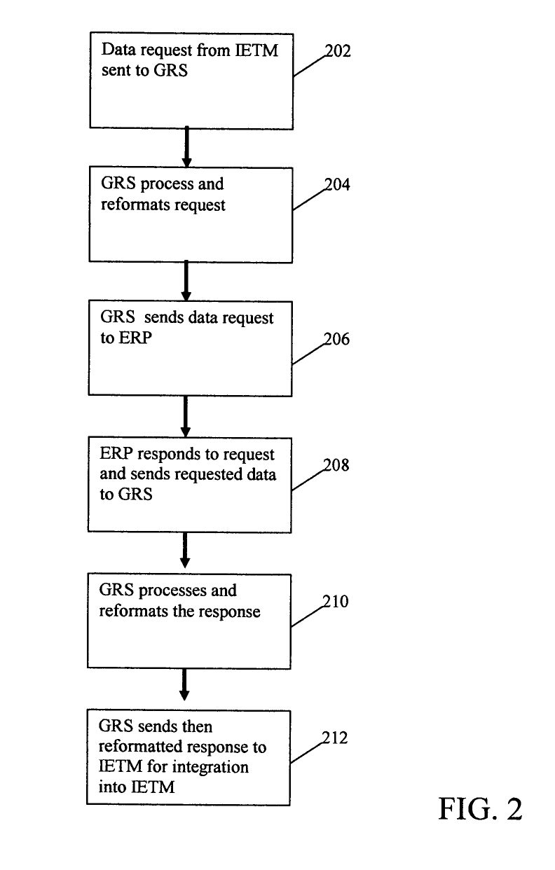

FIG. 2 shows the steps for updating IETM 102. First a data request is sent from IETM 102 to GRS 104, Step 202. The data request may be initiated manually or automatically such as when IETM 102 is loaded onto a computer. Next, GRS 104 processes and reformats the data request into a request ERP 108 will recognize, Step 204. Then the reformatted request is sent to ERP 108, Step 206. ERP 108 processes and responds to the request and sends the requested data back to GRS 104, Step 208. GRS 104 then processes and reformats the response from ERP 108 into a response IETM 102 will recognize, Step 210. Finally, GRS 104 sends the reformatted response to IETM 102 for integration into IETM 102, Step 212.

For example, if the price, availability, and location of a part is requested for inclusion in IETM 102, then IETM 102 sends the request to GRS 104. GRS 104 queries ERP 108 for the requested information and forwards the response to IETM 102 to be integrated into IETM 102. In this manner, GRS allows the separation of business logic and other logic in ERP 108 from the data to be used in IETM 102. This causes the data in IETM 102 to be synchronized with the data in ERP 108.

IETM 102 also enables users to purchase parts through open system, industry standard source formats. Parts listed in IETM 102 are hyper-linked to GRS 104 via ethernet 106 or the Internet. The hyper-link accesses a requisition request application in GRS 104. After the requisition request application is completed, GRS 104 forwards the requisition request to ERP 108 via ethernet connection 110, or the Internet, where the requisition request is processed by ERP 108 as is known in the art. The process allows parts to be directly purchased from IETM 102.

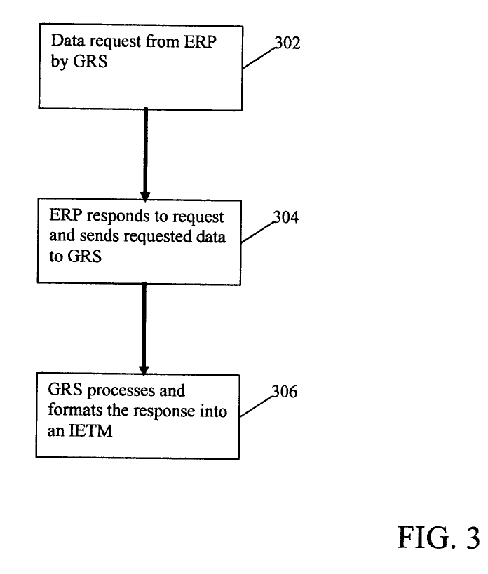

GRS 104 can also create a customized IETM by querying ERP 108 for parts, part numbers, price, availability, and other information related to a specific part. FIG. 3 shows the steps used to create a customized IETM. First the data used to create the customized IETM is requested from ERP 108 by GRS 104, Step 302. The requested data can be any information associated with any product or part found or listed in ERP 108. For example, if ERP 108 contains information about what material each part is made from, then the requested data may be for all aluminum parts found or listed in ERP 108. Next, ERP 108 responds to the request and sends the requested data to GRS 104, Step 304. Finally, GRS 104 processes and formats the response into a customized IETM, Step 306.

GRS 104 can also update information in ERP 108 with data from OEM 112. GRS 104 is programmed with details such as syntax, data format, data types and catalog naming conventions used by ERP 108 and OEM 112. At periodic intervals, such as at the end of every month or week, GRS 104 queries OEM 112 for data regarding all products or parts found or listed in ERP 108. The results of the query are used to update ERP 108.

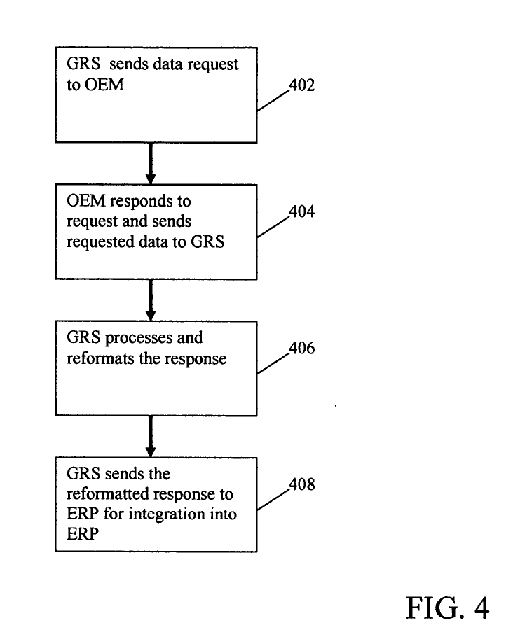

FIG. 4 shows the steps used to obtain updated information from OEM 112. First GRS 104 sends a data request to OEM 112 for information regarding all products or parts found or listed in ERP 108, Step 402. OEM 112 responds to the request and sends the requested data to GRS 104, Step 404. GRS 104 process and reformats the requested data into a format ERP 108 can recognize, Step 406 The reformatted data is sent to ERP 108 for integration into ERP 108, Step 408. This enables ERP 108 to have the most updated information about each product or part contained within ERP 108. Also, because IETM 102 is updated with the data in ERP 108, the information in IETM 102 is the most current and up to date.

While XML is used to move data between applications in another embodiment, ASP may also be used to move data between applications.

Although the invention has been described with reference to one or more preferred embodiments, this description is not to be construed in a limiting sense. There is modification of the disclosed embodiments, as well as alternative embodiments of this invention, which will be apparent to persons of ordinary skill in the art, and the invention shall be viewed as limited only by reference to the following claims.

What is claimed is:

1. A method for combining and synchronizing data in an enterprise resource planning system with an interactive electronic technical manual, the method comprising the steps of:
identifying an enterprise resource planning system that contains a product;
identifying an interactive electronic technical manual that displays information about the product;
operationally connecting the enterprise resource planning system to the interactive electronic technical manual;
receiving a request for information about the product from the interactive electronic technical manual;
processing the request from the interactive electronic technical manual into a request the enterprise resource planning system will recognize;
sending the processed request to the enterprise resource planning system;
receiving a response to the processed request from the enterprise resource planning system;
processing the response from the enterprise resource planning system into a response the interactive electronic technical manual will recognize; and
sending the processed response to the interactive electronic technical manual.

2. The method of claim 1 wherein the enterprise resource planning system and the interactive electronic technical manual are operationally connected using middleware.

3. The method of claim 1 wherein the interactive electronic technical manual and the enterprise resource planning system are operationally connected via an ethernet.

4. The method of claim 1 wherein the interactive electronic technical manual and the enterprise resource planning system are operationally connected via the Internet.

5. The method of claim 1 further comprising operationally connecting the enterprise resource planning system to an original equipment manufactures database.

6. The method of claim 5 wherein the information in the information in the original equipment manufactures database is used to update information in the enterprise resource planning system at a defined update interval.

7. The method of claim 1 wherein the interactive electronic technical manual is created using an IETM viewer.

8. The method of claim 1 wherein a part listed in the interactive electronic technical manual may be ordered by selecting a hyperlink associated with the listed part.

9. A method for creating a customized interactive electronic technical manual, the method comprising the steps of:
identifying an enterprise resource planning system that contains data about a plurality of products;
requesting specific information from the enterprise resource planning system about the plurality of products;
receiving the requested specific information; and
integrating the requested specific information into a customized interactive electronic technical manual.

10. The method of claim 9 wherein the specific information is requested using middleware.

11. The method of claim 10 wherein the middleware and the enterprise resource planning system are operationally connected via an ethernet.

12. The method of claim 10 wherein the middleware and the enterprise resource planning system are operationally connected via the Internet.

13. The method of claim 10 comprising the additional steps of synchronizing the specific information in the customized interactive electronic technical manual with the data in the enterprise resource planning system, wherein the step of synchronization includes the steps of:
operationally connecting the enterprise resource planning system to the customized interactive electronic technical manual;
receiving a request for information from the customized interactive electronic technical manual;
processing the request from the customized interactive electronic technical manual into a request the enterprise resource planning system will recognize;
sending the processed request to the enterprise resource planning system;
receiving a response to the processed request from the enterprise resource planning system;
processing the response from the enterprise resource planning system into a response the customized interactive electronic technical manual will recognize; and
sending the processed response to the customized interactive electronic technical manual.

14. The method of claim 9 further comprising operationally connecting the enterprise resource planning system to an original equipment manufactures database.

15. The method of claim 14 wherein the information in the original equipment manufactures database is used to update information in the enterprise resource planning system at a defined update interval.

16. The method of claim 9 wherein a part listed in the customized interactive electronic technical manual may be ordered by selecting a hyperlink associated with the listed part.

17. A method for updating an enterprise resource planning system, the method comprising the steps of:
identifying an enterprise resource planning system that contains a product;
identifying an original equipment manufacture's database that contains information about the product;
operationally connecting the enterprise resource planning system to the original equipment manufacture's database;
receiving a request for information about the product from the enterprise resource planning system;
processing the request from the enterprise resource planning system into a request the original equipment manufacture's database will recognize;
sending the processed request to the original equipment manufacture's database;
receiving a response to the processed request from the original equipment manufacture's database;
processing the response from the original equipment manufacture's database into a response the enterprise resource planning system will recognize; and
sending the processed response to the enterprise resource planning system.

18. The method of claim 17 wherein the enterprise resource planning system and the original equipment manufacture's database are operationally connected using middleware.

19. The method of claim 17 wherein the enterprise resource planning system and the original equipment manufacture's database are operationally connected via an ethernet.

20. The method of claim 17 wherein the enterprise resource planning system and the original equipment manufacture's database are operationally connected via the Internet.
